(19) United States
(12) Patent Application Publication
(10) Pub. No.: US 2008/0233026 A1
(43) Pub. Date: Sep. 25, 2008

(54) Method and system for NOx removal

(75) Inventor: Dennis J. Laslo, Knoxville, TN (US)

Correspondence Address: WIGGIN AND DANA LLP, ONE CENTURY TOWER, P.O. BOX 1832, NEW HAVEN, CT, 06508-1832, US

(73) Assignee: ALSTOM Technology Ltd

(21) Appl. No.: 11/726,338

(22) Filed: Mar. 20, 2007

(51) Int. Cl. B01D 53/56; B01D 50/00

(52) U.S. Cl. 423/239.1; 422/178

(57) ABSTRACT

A method and system for removing pollutants from a flue gas stream (20) by utilizing excess ammonia present in the system as a reagent for NOx removal. The method includes contacting the flue gas stream (20) with an ammonia scrubbing solution (29) and passing the flue gas stream (20) through a selective catalytic reduction system (32), wherein the selective reduction system (32) utilizes excess ammonia present in the flue gas stream (20) as a reagent to remove NOx from the flue gas stream (20).

### BACKGROUND

1. Field

The disclosed subject matter relates to a method and system for using excess ammonia in a pollutant removal system to effect removal of NOx from a flue gas stream.

2. Description of the Related Art

Burning of fossil fuels emits many toxins such as mercury, nitric oxide, nitrogen dioxide (together referred to as “NOx”) as well as sulfur dioxide and sulfur trioxide (together referred to as “SOx”). Removal of these byproducts from flue gases has been an area of interest for many years due to their negative effects on the environment. The release of NOx and SOx into the atmosphere can contribute to acid rain and also cause the formation of photochemical oxidants such as ozone. Many methods have been developed that utilize various reagents, including alkaline materials, activated carbon and ammonia in various processes to reduce the amount of these and other toxins that are emitted into the environment.

Selective catalytic reduction systems (SCR) have been in development since the middle of the 1970s. SCR systems are used widely to reduce emission of NOx that is formed in combustion processes. NOx is converted to pure nitrogen and water in an SCR system by using a catalyst with ammonia distributed thereon.

There are many SCR systems that presently use ammonia as the reduction agent. However, utilization of this reagent can be particularly problematic in the known processes. For example, when using ammonia, a certain amount of the ammonia is typically released from the SCR system and emitted into the atmosphere, making the process more costly and polluting the environment. This emission, commonly referred to as “ammonia slip,” may lead to environmental problems.

Additional methods available to effect removal of pollutants from a flue gas include wet and dry scrubbing systems. Scrubbing systems typically remove acid gases such as SOx or carbon dioxide from the flue gas stream by scrubbing the gas with a reagent in solution form. The reagent can be, for example, aqueous ammonia and reaction products including salts of ammonia such as ammonia sulfate and ammonia carbonate/bicarbonate. This method generally has improved performance when the pH level of the ammonia scrubbing solution is maintained at a high level.

High pH levels produce aerosols of ammonia that can emanate into the air. To reduce the level of ammonia slip, the pH level must be lowered, which consequently lowers the performance of the scrubber system.

### BRIEF SUMMARY

One aspect of the disclosed subject matter relates to a process for removing pollutants from a flue gas stream with an ammonia scrubbing solution. The process includes contacting the flue gas stream with an ammonia scrubbing solution and passing the flue gas stream through a selective catalytic reduction (SCR) system. The SCR system is configured to utilize excess ammonia present in the flue gas stream as a reagent to reduce an amount of NOx present in the flue gas stream.

Another aspect of the disclosed subject matter relates to a process for utilizing ammonia to effect reduction of pollutants present in a flue gas stream. The process includes introducing a flue gas stream to a scrubbing system, contacting the flue gas stream with an ammonia scrubbing solution in the scrubbing system and passing the flue gas stream through a selective catalytic reduction (SCR) system. The SCR system is configured to utilize ammonia present in the flue gas stream to effect removal of NOx from the flue gas stream.

Another aspect of the disclosed subject matter relates to a system for removing pollutants from a flue gas stream. The system includes a scrubber for scrubbing the flue gas stream with an ammonia scrubbing solution to produce a flue gas stream of reduced pollutant content and a selective catalytic reduction (SCR) system for reducing an amount of NOx present in the flue gas stream, wherein the SCR system utilizes excess ammonia present in the scrubber as a reagent to remove NOx from the flue gas stream.

The details of one or more embodiments are set forth in the accompanying drawings and the description below. Other features, objects and advantages will be apparent from the description and drawings, and from the claims.

### BRIEF DESCRIPTION OF THE DRAWINGS

For the purpose of illustrating the embodiments, the drawings show a form of the embodiments that is presently preferred. However it should be understood that the disclosed subject matter is not limited to the precise arrangements and instrumentalities shown in the drawings, wherein:

FIG. 1 is a schematic of a system for treating flue gas and releasing it to the atmosphere according to one embodiment of the disclosed subject matter.

### DETAILED DESCRIPTION

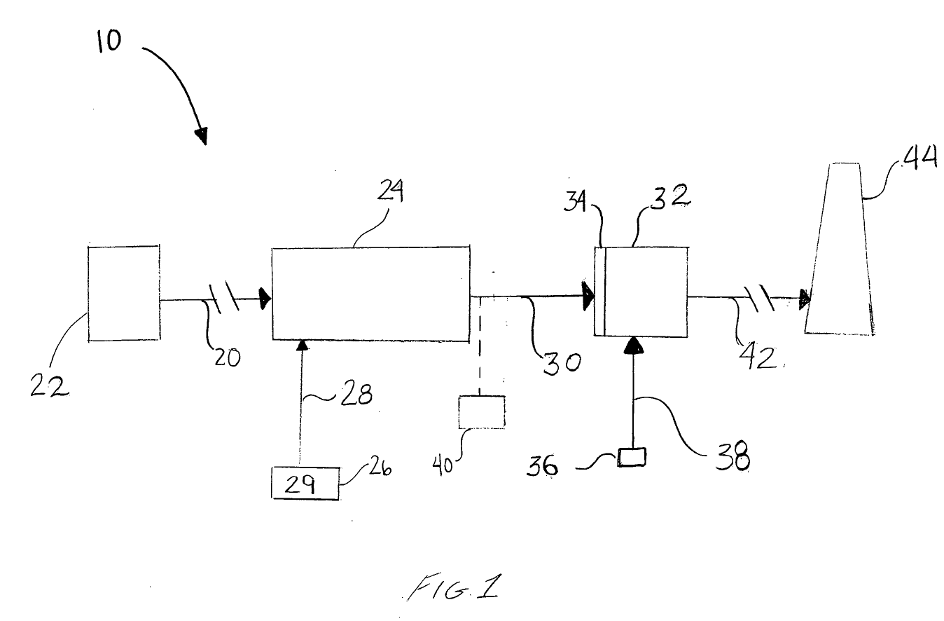

Referring now to FIG. 1, one embodiment is a process and system 10 for removing an amount of pollutants present in a flue gas stream, which utilizes a process for cleaning a flue gas stream 20 produced by a combustion source 22, e.g. boiler. Flue gas stream 20 is produced upon combustion of a fuel, such as coal. Flue gas stream 20 includes acidic gases such as sulfur trioxide and sulfur dioxide (SOx), and nitric oxide, nitrogen oxide and nitrogen dioxide (NOx), particulate material referred to as fly ash, mercury and other various pollutants.

After leaving combustion source 22, flue gas stream 20 is routed through various systems and processes to remove or reduce the concentration of pollutants contained therein. In addition to the system and processes in FIG. 1, flue gas stream 20 can be directed through a particulate collector (not shown), which may be a fabric filter, an electrostatic precipitator (ESP), or the like, to remove particulates from the flue gas stream.

Flue gas stream 20 is then subjected to one or more scrubbing systems to remove acid gases such as carbon dioxide (CO₂), SOx, NOx, and mercury. As shown in FIG. 1, flue gas stream 20 is directed to a scrubber system 24 where the flue gas stream is contacted with one or more reagents to produce a flue gas stream that has a reduced concentration of acid gases.

Scrubber system 24 utilizes one or more reagents to remove acidic gases, such as SOx, from flue gas stream 20. The reagents are usually in solution form and are provided to scrubber system 24 by a tank 26 via a conduit 28. Bringing the reagents into contact with flue gas stream 20 removes or reduces the concentration of the acid gases contained therein.

Typical reagents useful in scrubber 24 include an ammonia scrubbing solution 29, which is stored in tank 26. Ammonia scrubbing solution 29 may include different compounds and/or components based on the purpose of scrubber 24. For example, if scrubber 24 is used to remove SOx from flue gas stream 20, then ammonia scrubbing solution 29 may contain ammonia, ammonium sulfite, ammonium sulfate, and water. However, if scrubber 24 is used to remove carbon dioxide from flue gas stream 20, ammonia scrubbing solution 29 may contain ammonia carbonate, ammonia bicarbonate, ammonia carbamate, and like compounds. If a carbon dioxide scrubber follows an SOx scrubber, the carbon dioxide scrubber will contain ammonia, ammonium sulfite, ammonium sulfate, and water as well as ammonia carbonate, ammonia bicarbonate, ammonia carbamate, and like compounds.

Ammonia scrubbing solution 29 typically has a pH between about 6 and about 8. The high pH of ammonia scrubbing solution 28 facilitates the removal of the pollutant gases from flue gas stream 20. However, due to the higher vapor pressure of ammonia, ammonia scrubbing solution 29 creates gaseous ammonia, usually in the form of aerosols (not shown).

The gaseous ammonia created in scrubber 24, referred to as “ammonia slip”, may travel with flue gas stream 20 as it exits scrubber 24. Absent further treatment of flue gas stream 20 to remove ammonia, the ammonia slip will be released to the atmosphere along with flue gas stream 20.

After being subjected to ammonia scrubbing solution 29 in scrubber 24, a reduced acid gas flue gas stream 30 is then carried to a selective catalytic reduction (SCR) system 32. Due to the ammonia gas and perhaps ammonia aerosols created in scrubber 24, flue gas stream 30 typically contains ammonia.

Prior to entering SCR system 32, flue gas 30 is heated by a heating element 34. Heating element 34 can be any device effective to raise the temperature of flue gas 30 to a temperature appropriate for SCR system 32. For example, heating element 34 can be an air pre-heater with a supplemental combustor.

SCR system 32 facilitates the removal or the reduction in the concentration of various pollutants present in flue gas stream 30 through the use of a catalyst (not shown). SCR system 32 is generally effective at reducing the amount of NOx in flue gas stream 30. In an embodiment of the present system and process, the ammonia present in flue gas stream 30, which was created in scrubber 24 and directed to SCR system 32, is utilized as the catalyst in the SCR system.

In another embodiment of the present system and process, ammonia carried to SCR system 32 by flue gas 30 is supplemented. Ammonia stored in a tank 36 is fed to SCR system 32 via a conduit 38, by utilizing conventional means, such as an ammonia injection grid (AIG).

Alternatively, to ensure there is not excessive ammonia slip in flue gas stream 30 that will not react with NOx and instead will exhaust to the atmosphere, additional ammonia can be added to flue gas stream 30 prior to it reaching SCR system 32. In this embodiment, an optional ammonia analyzer 40 is placed downstream of scrubber 24 and upstream of SCR system 32. Ammonia analyzer 40 measures the amount of ammonia present in flue gas stream 30 after the flue gas stream leaves scrubber 24. If more ammonia is needed in flue gas stream 30 to remove NOx from the flue gas stream, additional ammonia scrubbing solution 29 may be added to scrubber 24.

The ammonia used in SCR system 32 reacts with NOx in flue gas stream 30 to produce nitrogen and water, which are harmless to the environment and therefore can be exhausted into the atmosphere.

A flue gas stream 42 having a reduced NOx amount is passed from SCR system 32 to stack 44. Between SCR system 32 and stack 44, flue gas stream 42 can be subjected to other processes to remove or reduce other pollutants present in the flue gas stream, such as mercury removal processes.

Use of ammonia to remove or reduce a concentration of pollutants within a flue gas stream is enhanced by the present system and process. By utilizing ammonia aerosol or “ammonia slip” generated by the scrubber 24 to remove or reduce the concentration of NOx in the flue gas stream, it eliminates or reduces the amount of ammonia that is released into the atmosphere.

Additionally, using the ammonia slip created in scrubber 24 as a catalyst in SCR system 32 reduces the amount of “fresh” ammonia required by the system to facilitate removal or reduction of NOx in the flue gas stream. As can be appreciated by those skilled in the art, this system and process reduces the amount of waste and reduces the cost associated with these systems.

Although the present system and process has been described and illustrated with respect to embodiments thereof, it should be understood by those skilled in the art that the foregoing and various other changes, omissions and additions can be made therein and thereto, without parting from the spirit and scope of the present system and process. Accordingly, other embodiments are within the scope of the following claims.

What is claimed is:

1. A process for removing pollutants from a flue gas stream with an ammonia scrubbing solution, the process comprising:
contacting the flue gas stream with an ammonia scrubbing solution; and
passing said flue gas stream through a selective catalytic reduction (SCR) system, wherein said SCR system is configured to utilize excess ammonia present in said flue gas stream as a reagent to reduce an amount of NOx present in said flue gas stream.

2. A process according to claim 1, wherein the ammonia scrubbing solution reduces an amount of acid gas content present in said flue gas stream.

3. A process according to claim 1 further comprising:
supplying additional ammonia to said SCR system to react with said NOx in said flue gas stream.

4. A process according to claim 1 further comprising:
subjecting said reduced NOx content flue gas stream to additional pollutant removal systems.

5. A process according to claim 1, wherein said ammonia scrubbing solution comprises ammonia, ammonium sulfite, ammonium sulfate, and water.

6. A process according to claim 1, wherein said ammonia scrubbing solution comprises ammonia carbonate, ammonia bicarbonate, and ammonia carbamate.

7. A process according to claim 1, wherein said ammonia scrubbing solution has a pH between about 6 and about 8.

8. A process for utilizing ammonia to effect reduction of pollutants present in a flue gas stream, said process comprising:
introducing said flue gas stream to a scrubbing system;
contacting said flue gas stream with an ammonia scrubbing solution in said scrubbing system; and
passing said flue gas stream through a selective catalytic reduction (SCR) system, wherein said SCR system is configured to utilize ammonia present in said flue gas stream to effect removal of NOx from said flue gas stream.

9. A process according to claim 8, wherein said scrubbing system reduces a concentration of pollutants in said flue gas stream to produce a flue gas stream having a reduced acid gas content.

10. A process according to claim 8, further comprising:
supplying additional ammonia to said SCR system to effect removal of NOx from said flue gas stream.

11. A process according to claim 8, further comprising:
subjecting said reduced NOx content flue gas stream to additional pollutant removal systems.

12. A process according to claim 8, wherein said ammonia scrubbing solution comprises ammonia carbonate, ammonia bicarbonate, and ammonia carbamate.

13. A process according to claim 8, wherein said ammonia scrubbing solution comprises ammonia, ammonium sulfite, ammonium sulfate, and water.

14. A process according to claim 8, wherein said ammonia scrubbing solution has a pH between about 6 and about 8.

15. A system for removing pollutants from a flue gas stream, the system comprising:
a scrubber for scrubbing said flue gas stream with an ammonia scrubbing solution to produce a flue gas stream of reduced pollutant content; and
a selective catalytic reduction (SCR) system for reducing an amount of NOx present in said flue gas stream,
wherein said SCR system utilizes excess ammonia present in said scrubber as a reagent to remove said NOx from said flue gas stream.

16. A system according to claim 15, further comprising:
means for introducing additional ammonia to said SCR system.

17. A system according to claim 15, wherein said ammonia scrubbing solution comprises ammonia, ammonium sulfite, ammonium sulfate, and water.

18. A system according to claim 15, wherein said ammonia scrubbing solution comprises ammonia carbonate, ammonia bicarbonate, and ammonia carbamate.

19. A system according to claim 15, wherein said ammonia scrubbing solution has a pH between about 6 and about 8.

20. A system according to claim 15, further comprising means for elevating a temperature of said flue gas stream present in said SCR system.
